(19) United States
(12) Patent Application Publication
(10) Pub. No.: US 2007/0140287 A1
(43) Pub. Date: Jun. 21, 2007

(54) Controlling the configuration of a transmission path

(76) Inventors: Thomas Sean Houlihane, Herts (GB); Edmond John Simon Ashfield, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 11/312,645

(22) Filed: Dec. 21, 2005

(51) Int. Cl. H04J 3/16

(52) U.S. Cl. 370/437; 370/442

(57) ABSTRACT

A method, system and unit for controlling the configuration of a transmission path coupling a first unit and a second unit is disclosed. The first unit and the second unit are configurable to support the transfer of information items over the transmission path in time-slots of successive transmission frames in accordance with a plurality of modes, each of the plurality of modes allocating differing numbers of time-slots within each frame to different types of information items. The method comprises the steps of: programming control logic of the first unit and the second unit with an indication of an ordered subset of the plurality of modes to be supported by the first unit and the second unit; configuring the first unit and the second unit to support the transfer the information items over the transmission path using a default one of the plurality of modes; and responsive to an indication requesting that a different mode be selected, causing the first unit and the second unit to be configured to support the next in the ordered subset of the plurality of modes indicated by the control logic. By providing within each unit a predetermined ordered list of modes to be supported by those units, it is only necessary to provide an indication that some change is required and the mode which needs to be changed to can be determined simply by referring to the ordered list. It will be appreciated that this provides a mechanism to switch efficiently between modes, significantly reduces the amount of data required to indicate the new mode and may improve the efficiency of total data transaction.

### BACKGROUND OF THE INVENTION

1. Field of the Invention

The present invention relates to techniques for controlling the configuration of a transmission path. Embodiments of the present invention relate to controlling the configuration of a transmission path coupling units, the transmission path being configurable to transfer information items between the units in accordance with a plurality of modes.

2. Description of the Prior Art

It is often required to control the configuration of a transmission path coupling units. For example, during the debug of a data processing apparatus, it is necessary to control the configuration of a transmission path coupling the data processing apparatus being debugged with a debugger in order to enable the transfer of information items therebetween.

In one known arrangement, there is provided a so-called “JTAG” interface for coupling a debugger A with a data processing apparatus B, as illustrated in FIG. 1. In this arrangement, the debugger A is coupled with the data processing apparatus B via a five-wire JTAG interface. The JTAG interface comprises a path TCK for carrying a clock signal, a path TDI for transferring data items from the debugger A to the data processing apparatus B, a path TMS for transferring control information from the debugger A to the data processing apparatus B, a path TDO for transferring data items from the data processing apparatus B to the debugger A and a path NTRST for transmitting a reset signal from the debugger A to the data processing apparatus B. When using such a five-wire system, it will be appreciated that it is possible to transmit the clock signal, bi-directional data items and a control signal simultaneously over the paths provided.

A typical transaction performed over the JTAG interface is also illustrated in FIG. 1. As can be seen, four bits of control data are initially transmitted over the path TMS to the data processing apparatus B. Thereafter, the debugger A will transmit typically 32 bits of data over the path TDI to the data processing apparatus B. In response, the data processing apparatus will at the same time transmit typically two bits of data over the path TDO to the debugger A. Hence, assuming that one bit can be transmitted in each direction in each cycle, a typical transaction of this form will take 36 cycles to complete.

However, as can be clearly seen from FIG. 1, many of the paths of the JTAG interface remain dormant for large periods of the transaction. Also, providing five-wire interface requires five corresponding external pins to be provided to support the JTAG interface. Providing such pins is generally undesirable since these pins are costly, the pins will typically not be utilised during the normal operation of the data processing apparatus and so, given a finite supply of such pins, reduces the number of pins available for other purposes.

Accordingly, a so-called “Serialised JTAG (SJ)” interface has been proposed which reduces the number of external pins required down from five to two, as shown in FIG. 2.

This arrangement provides a path TCK′ and a path TMSC between the debugger A and the data processing apparatus B. The combination of the paths TCK′ and TMSC together enable encoded signals to be transmitted between the debugger A and the data processing apparatus B. The SJ encoding scheme enables commands to be sent which configure SJ interface controllers (not shown) provided within the debugger A and the data processing apparatus B, as well as enabling control and data items to be transmitted between the debugger A and the data processing apparatus B themselves. The SJ interface supports a number of different modes, which enable different combinations of commands, control items and data items to be transmitted, as will be explained in more detail below.

FIG. 2 also shows a typical arrangement of the data items transmitted over the SJ interface when supporting the transaction illustrated in FIG. 1.

Initially, the SJ interface is set to operate in a full mode. The set mode command which configures the units to adopt this mode takes up to 64 cycles to be transmitted. When operating in the full mode, data items from the debugger A to the data processing apparatus B (hereafter referred to as data-in), control items from the debugger A to the data processing apparatus B (hereafter referred to as control data) and data items from the data processing apparatus B to the debugger A (hereafter referred to as data-out) are time division multiplexed in sequential time-slots over the SJ interface. Accordingly, when operating in the full mode, a single transmission frame over the SJ interface comprises three time-slots.

Hence, the four bits of control data are transmitted within the control time-slot of four consecutive frames, which takes 12 cycles.

Thereafter, the 32 bits of data from the debugger A to the data processing apparatus B are transmitted in the data-in time-slot of the next 32 consecutive frames.

In the last two of those 32 consecutive frames, the two bits of data from the data processing apparatus B to the debugger A are transmitted in the data-out time-slot. Hence, the transmission of the data-in and the data-out takes 96 cycles.

Accordingly, this complete transaction now takes up to 172 cycles to complete. It can be seen that this is significantly longer than the 36 cycles which would be required by the JTAG interface.

Also, it will be appreciated that for the first four frames only a third of the available bandwidth is used, for the next thirty frames only a third of the available bandwidth is used and in the last two frames, two thirds of the available bandwidth is used.

However, the SJ interface can support various different modes. Included in these modes are the full mode described above, a down-link mode in which all time-slots are occupied by data-in, an up-link mode in which all time-slots are occupied by data-out and a equal mode in which alternating time-slots are allocated to data-in and then data-out.

FIG. 2 also illustrates how switching modes affects the performance of the SJ interface in response to the example transaction shown in FIG. 1.

As before, the SJ interface is configured to operate in the full mode, which takes up to 64 cycles.

Thereafter, control data is transmitted in every third time-slot of the first four frames, which takes a further 12 cycles.

Then, a set mode command is issued to change the mode to the equal mode, which takes up to 64 cycles to complete.

Thereafter alternating time-slots carry data-in and data-out. Hence, after a further 32 frames, each comprising 2 cycles, the data transaction has completed.

Accordingly, changing modes causes the number of cycles required to support the transaction to be increased to up to 204 cycles.

Thus it can be seen that whilst using a SJ interface significantly reduces the number of external wires required to be provided for debug, it will be appreciated that the performance impact of reducing to a two-wire approach is high.

Accordingly, it is desired to provide and improve technique for controlling the configuration of a transmission path coupling the units.

### SUMMARY OF THE INVENTION

Viewed from a first aspect, the present invention provides a method of controlling the configuration of a transmission path coupling a first unit and a second unit, the first unit and the second unit being configurable to support the transfer of information items over the transmission path in time-slots of successive transmission frames in accordance with a plurality of modes, each of the plurality of modes allocating differing numbers of time-slots within each frame to different types of information items, the method comprising the steps of: programming control logic of the first unit and the second unit with an indication of an ordered subset of the plurality of modes to be supported by the first unit and the second unit; configuring the first unit and the second unit to support the transfer the information items over the transmission path using a default one of the plurality of modes; and responsive to an indication requesting that a different mode be selected, causing the first unit and the second unit to be configured to support the next in the ordered subset of the plurality of modes indicated by the control logic.

The present invention recognises that whilst some interfaces, such as the SJ interface, provides modes which are particularly efficient for transactions where the data transfer is uni-directional or where each bit of data-in has a corresponding bit of data-out, these modes may not be not optimal for other types of transactions. Also, the present invention recognises that the relatively poor performance provided by, for example, the SJ interface for some transactions is compounded by the fact that the overhead associated with switching between modes to improve efficiency is often higher than the data to be transmitted once in that mode. Hence, any attempt to switch between modes for those types of transactions will, instead of decreasing the number of cycles required to perform those transactions, actually increase the number of cycles required.

Accordingly, control logic is provided within each unit which is provided with a predetermined list of modes to be supported by those units. The modes supported by those units are typically a subset of all the available modes. The units will typically transfer data over the transmission path initially in accordance with a predetermined or default mode. It will be appreciated that the number of time-slots within each frame may vary dependent on the mode. When an indication is received that a mode switch should occur then the units are configured to support the mode indicated by the next entry in the ordered list of modes. In this way, it will be appreciated that rather than having to provide an indication that not only is a mode change to occur but also what mode is to be changed to, by providing an ordered list it is only necessary to provide an indication that some change is required and the mode which needs to be changed to can be determined simply by referring to the ordered list. It will be appreciated that this can significantly reduce the amount of data required to indicate the new mode which in turn can improve the efficiency of total data transaction.

Hence, the present arrangement may improve the efficiency of transactions performed over, for example, the SJ interface when used with units which generate a non-equal mix of input and output data by providing a mechanism to switch efficiently between modes.

In one embodiment, the ordered subset of the plurality of modes comprises two of the plurality of modes.

Providing just two modes simplifies the control of switching between these modes and reduces the complexity of programming the units with the ordered subset of modes.

In one embodiment, the control logic of the first unit and the second unit each comprise a state machine operable to store the subset of the plurality of modes, each state machine being responsive to the indication to cause the first unit and the second unit to be configured to switch between each of the subset of the plurality of modes.

By providing a state machine, the synchronisation of modes in the two units may be simply achieved.

In one embodiment, one of the ordered subset of the plurality of modes comprises the default mode.

Accordingly, the units may be configured to initially start in a default mode and then switch to the first of the ordered subset of modes in response to the indication or, alternatively, the ordered subset may include the default mode.

In one embodiment, the ordered subset of the plurality of modes comprises a plurality of sequences of the plurality of modes.

Hence, each of the ordered subset of modes may be itself a sequence of modes rather than just a single mode. Providing a sequence of modes provides improved efficiency when it is known that a particular sequence of modes will need to be repeated.

In one embodiment, one of the sequences comprises a first of the plurality of modes operable to support transmission of a first type of information items for a first predetermined number of time-slots followed by a second of the plurality of modes operable to support transmission of a second type of information items for a second predetermined number of time-slots.

Hence, the sequence may be pre-programmed to support a particular mode for a number of cycles and then another mode for a further number of cycles. For example, considering the transaction shown in FIG. 2, the first in the sequence of modes may be the full mode for 4 cycles followed by the equal mode for 32 cycles. It will be appreciated that the sequence may provide any number of modes for any number of cycles, for example, the first in the sequence of modes may be the full mode for 4 cycles followed by the equal mode until a mode switch occurs.

In one embodiment, each frame comprises a plurality of time-slots, each information item being transmittable within one of the time-slots.

Hence, a single item of data may be transmitted within a single time-slot.

In one embodiment, the different types of information items comprise control information and data information.

Hence, the different types of information may include control information for controlling the units as well as data information transmitted between the units.

In one embodiment, one of the plurality of modes comprises a multiplex mode in which each time-slot within each frame is associated with a different type of information.

Hence, in the multiplex mode each of the time-slots within the frame may be associated with a different type of information. For example, the full mode described in FIG. 2 may be an example of the multiplex mode.

In one embodiment, the data information comprises transmission information and reception information.

Hence, the data information may include information transmitted from one data unit to the other as well as data information transmitted in the other direction.

In one embodiment, one of the plurality of modes comprises a transmission mode in which each time-slot within each frame is associated with transmission information.

Accordingly, the transmission mode supports the transmission of data in only one direction in every time-slot of each frame.

In one embodiment, one of the plurality of modes comprises a reception mode in which each time-slot within each frame is associated with reception information.

Accordingly, in the reception mode each time-slot within each frame supports the transmission of data in the other direction to the transmission mode.

In one embodiment, one of the plurality of modes comprises a duplex mode in which each time-slot within each frame is associated with either reception information or transmission information.

Accordingly, the time-slots within each frame may be equally divided to support data transmission in both directions. The equal mode described with reference to FIG. 2 above may be an example of the duplex mode.

In one embodiment, the step of programming control logic comprises programming control logic of the first unit and the second unit with the indication of the ordered subset of the plurality of modes to be supported by the first unit and the second unit based on expected quantities and types of information items predicted to be transmitted over the transmission path.

Accordingly, the ordered subset of modes may be programmed based on prior knowledge of the types of data transactions which are expected to be performed over the transmission path. It will be appreciated that this is particularly suited to those environments where the type of data transaction are predictable and where these transactions follow a repeated type of pattern or sequence.

In one embodiment, the transmission path comprises a single bi-directional path.

In one embodiment, the first unit comprises a debug unit and the second unit comprises a data processing unit to be debugged.

In one embodiment, the transmission path comprises a single bi-directional path and a path carrying a clock signal.

In one embodiment, the first unit comprises a test unit and the second unit comprises a data processing unit to be tested.

In one embodiment, the first unit comprises a configuration unit and the second unit comprises a data processing unit to be configured.

In one embodiment, the indication has a data length which is shorter than other control sequences used to configure the transmission path.

Accordingly, the time taken to provide the indication is typically less than the time taken to provide the other control sequences.

In one embodiment, the method comprises the step of: transferring the information items over the transmission path in accordance with the currently selected mode.

In one embodiment, there is provided a second transmission path coupling a third unit with one of the first and the second units, the method further comprising the steps of: reformatting data received by the one of the first and the second units for transmission over the second transmission path; and transmitting the data received by the one of the first and the second units over the second transmission path.

Hence, any data and control signals to be transmitted from the transmission path to the second transmission path are reformatted between the protocols supported by those two transmission paths. In this way, the data may be received over one of the transmission paths and then routed onwards over another transmission path using the appropriate protocol. It will be appreciated that this provides a convenient technique to enable the transmission path to be used with legacy interfaces.

In one embodiment, the second transmission path couples the third unit with the second unit, the third unit and the second unit being provided on-chip and the first unit being provided off-chip.

Hence, any legacy interfaces provided on-chip can continue to be used whilst the transmission path may be used for off-chip communications.

According to a second aspect of the present invention there is provided a system comprising: a first unit; a second unit; a transmission path coupling the first unit and the second unit, wherein the first unit and the second unit are configurable to support the transfer of information items over the transmission path in time-slots of successive transmission frames in accordance with a plurality of modes, each of the plurality of modes allocating differing numbers of time-slots within each frame to different types of information items, the first unit and the second unit comprising: control logic programmable with an indication of an ordered subset of the plurality of modes to be supported by that unit; configuration logic operable to configure that unit to support the transfer the information items over the transmission path using a default one of the plurality of modes; and change logic responsive to an indication requesting that a different mode be selected to cause that unit to be configured to support the next in the ordered subset of the plurality of modes indicated by the control logic.

In embodiments, there is provided logic operable to perform the method steps of the first aspect.

According to a third aspect of the present invention there is provided a unit for controlling the configuration of a transmission path coupled thereto and to a second unit, the unit being configurable to support the transfer of information items over the transmission path in time-slots of successive transmission frames in accordance with a plurality of modes, each of the plurality of modes allocating differing numbers of time-slots within each frame to different types of information, the unit comprising: control logic programmable with an indication of an ordered subset of the plurality of modes to be supported; configuration logic for supporting the transfer the information items over the transmission path using a default one of the plurality of modes; and change logic responsive to an indication requesting that a different mode be selected for causing the next in said ordered subset of said plurality of modes indicated by said control logic to be supported.

In embodiments, there is provided means for performing the method steps of the first aspect.

The above, and other objects, features and advantages of this invention will be apparent from the following detailed description of illustrative embodiments which is to be read in connection with the accompanying drawings.

### BRIEF DESCRIPTION OF THE DRAWINGS

Embodiments of the present invention will now be described with reference to the accompanying drawings in which:

FIG. 1 illustrates the arrangement of a JTAG interface;

FIG. 2 illustrates the arrangement of a SJ interface;

FIGS. 3A to 3C illustrates the arrangement of a SJ interface having mode control logic according to one embodiment;

FIG. 4 is a flow chart illustrating the operation of the arrangement shown in FIG. 3; and

FIG. 5 illustrates an arrangement utilising differing interfaces.

### DESCRIPTION OF THE EMBODIMENTS

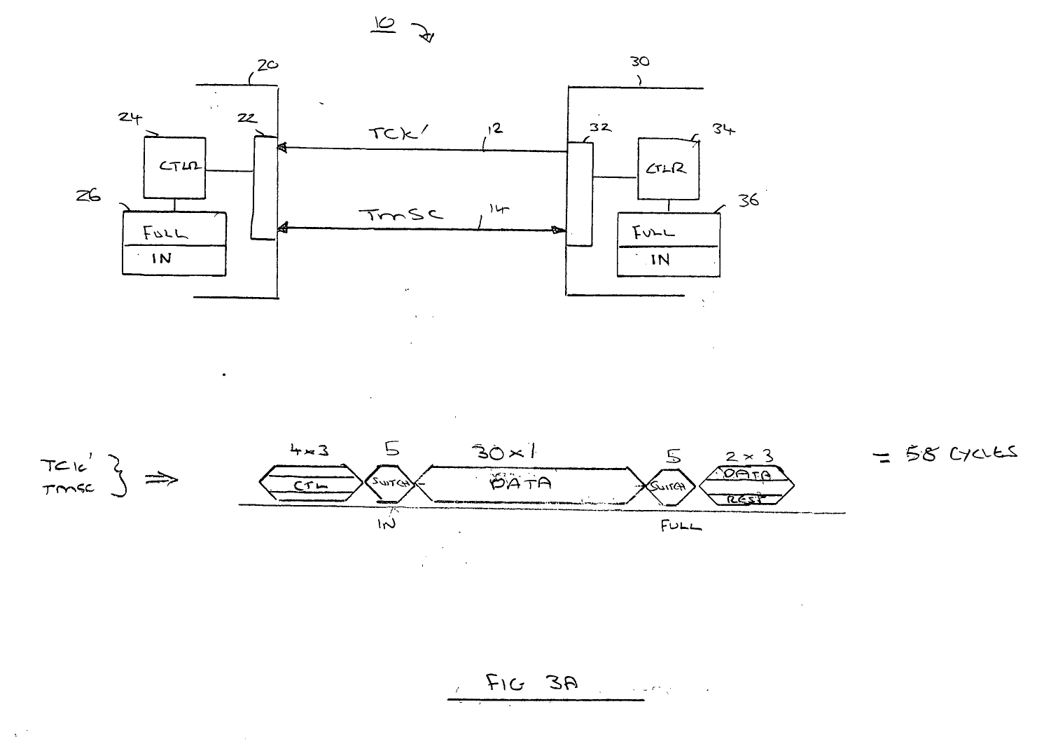

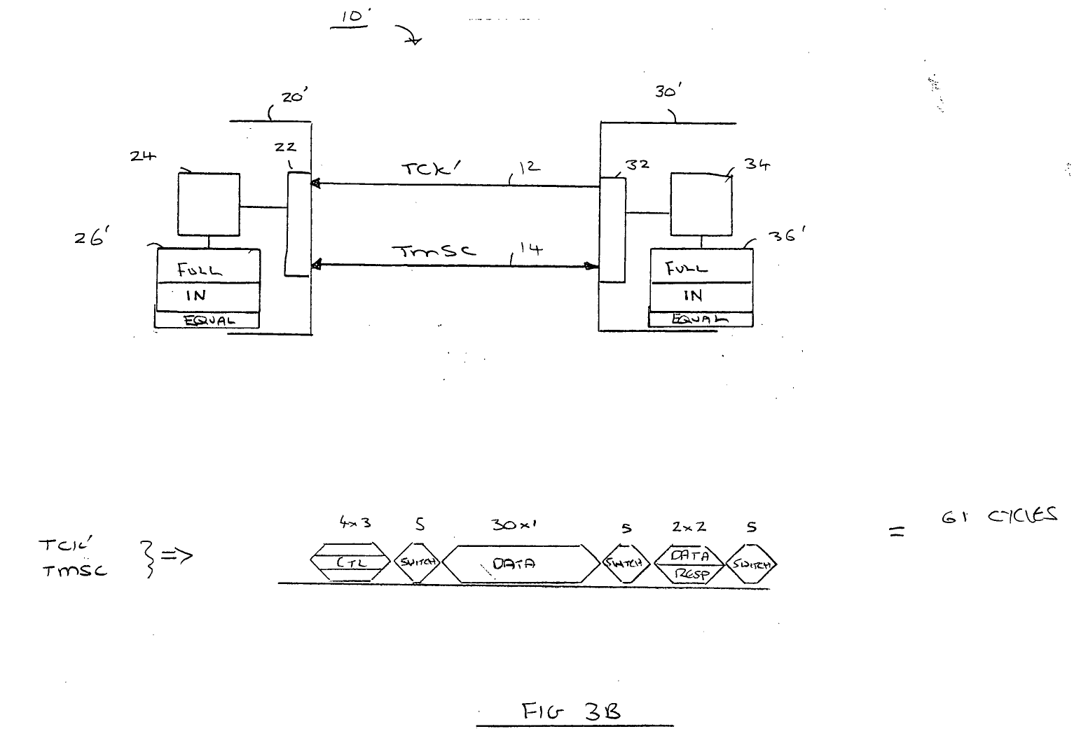

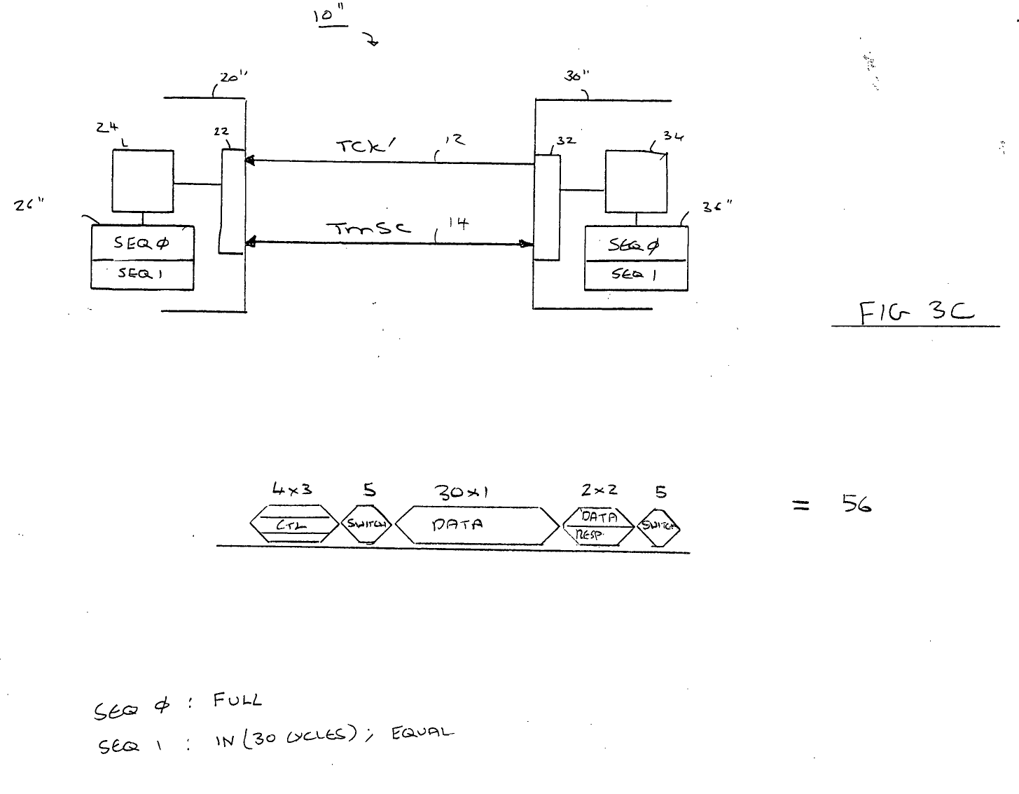

FIG. 3A illustrates a system 10 including an arrangement of a SJ interface according to one embodiment of the present invention. A TCK′ path 12 and a TMSC path 14 couple a data processing apparatus 20 with a debugger 30. The data processing apparatus 20 receives the TCK′ path 12 and the TMSC path 14 at a SJ interface unit 22. The configuration of the SJ interface unit 22 is controlled by a controller 24. The controller 24 is responsive to a state machine 26 which provides configuration information to be used by the controller 24 when configuring the SJ interface unit 22. Similarly, the debugger 30 receives the TCK′ path 12 and the TMSC path 14 at a SJ interface unit 32. The configuration of the SJ interface unit 32 is controlled by a controller 34. The controller 34 is responsive to a state machine 36 which provides configuration information to be used by the controller 34 when configuring the SJ interface unit 32.

In this embodiment, the state machine 26 and the state machine 36 are identical. On initialisation, the same state, such as, for example, full mode is selected in both state machines. This enables both the SJ interface unit 22 and the SJ interface unit 32 to be configured in the same mode. As will be explained in more detail below, the state machines 26, 36 are arranged to switch between the two predetermined modes (in this case the full mode and the in mode) in response to a switch command. In this way, it will be appreciated that this enables the SJ interface to be switched alternatively between the full mode and the in mode. Although this also increases the time required for all other command sequences, the other command sequences are only used occasionally such as, for example, the initial configuration of the link.

The switch command is effected using an escape sequence which is already predefined in the SJ format. The escape sequence consists of a 3 bit sequence on the TMSC path 14, with the TCK′ path 12 being held high. The switch command requires an extension of the escape sequence which allows the selected scan mode to be changed as well. This additional overhead requires a further two clock cycles for the word transfer which increases the total time to transmit the command to 5 cycles.

Whilst the arrangement shown in FIG. 3A shows providing the full mode and the in mode, it will be appreciated that the state machines 26, 36 could be arranged to alternatively switch between any two modes supported by the SJ interface.

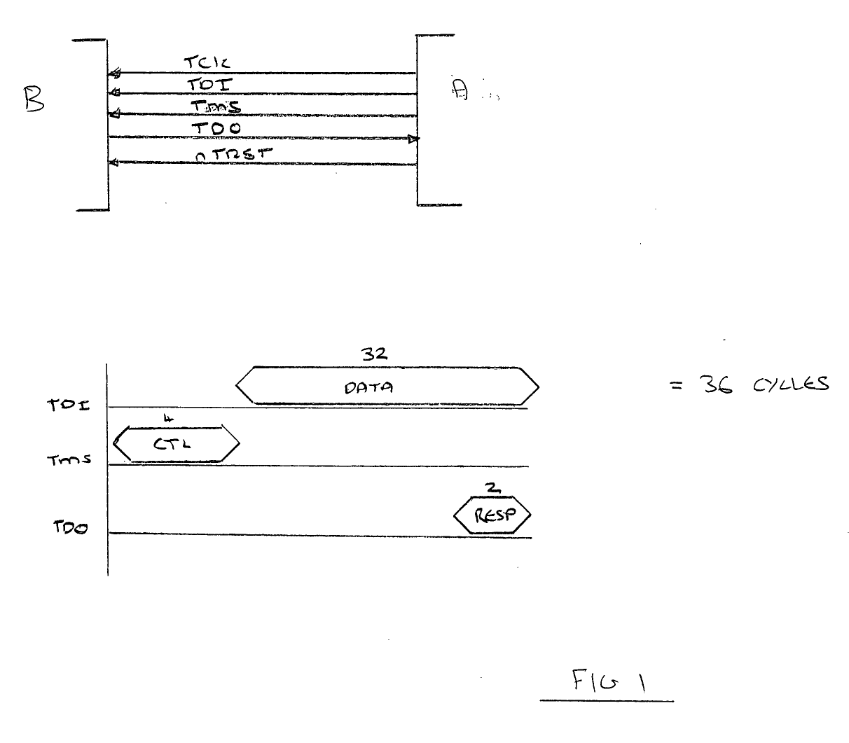

Considering now the data transaction shown in FIG. 1, but performed using the arrangement shown in FIG. 3A.

When the SJ interface is first initiated, the state machines 26, 36 initiate in the full mode and the controllers 24, 34 cause the SJ interface units 22, 32 to operate in the full mode. Accordingly, each frame transmitted over the SJ interface will consist of three time-slots, the first time-slot containing data to be transmitted from the debugger 30 to the data processing apparatus 20 (data-in), the second time-slot containing control information to be transmitted from the debugger 30 to the data processing apparatus 20 and the third time-slot in each frame containing any data to be transmitted from the data processing apparatus 20 back to the debugger 30 (data-out).

Hence, to transmit the four bits of control information takes four frames, each of which takes three cycles. Accordingly, to transmit the control information takes 12 cycles.

Thereafter, a switch command is sent over the SJ interface and this takes 5 cycles.

In response to the switch command, the state machines 26, 36 switch to the alternate mode. In this example, the state machines 26, 36 switch from the fill mode to the in mode. In response to this switch, the controllers 24, 34 configure the SJ interface units 22, 32 to operate in the in mode.

When operating in the in mode, each frame comprises one time slot for the transmission of data from the debugger 30 to the data processing apparatus 20 (data-in). Accordingly, to transmit the first thirty bits of data from the debugger 30 to the data processing apparatus 20 will take 30 cycles.

Thereafter, a further switch command will be issued, which takes 5 cycles.

In response to the switch command, the state machines 26, 36 will switch to the alternate mode, namely from the in mode back to the full mode. In response to this switch, the controllers 24, 34 will reconfigure the SJ interface units 22, 32 to operate in the full mode.

Accordingly, each frame now consists of 3 time-slots. The remaining two bits of data transmitted from the debugger 30 to the data processing apparatus 20 (data-in) and the two bits of response data transmitted from the data processing apparatus 20 to the debugger 30 (data-out) will take a further two frames, which takes 6 cycles.

Accordingly, it can be seen that the arrangement in FIG. 3a takes 58 cycles to perform the data transaction shown in FIG. 1 when using the SJ interface.

FIG. 3B illustrates a system 10′ including an arrangement of a SJ interface according to another embodiment of the present invention. In this embodiment, the state machines 26′, 36′ have three states between which they may switch, in order to select different modes. In this example, the state machines 26′, 36′ switch sequentially between the full mode, the in mode and the equal mode, however, it will be appreciated that the state machines 26′, 36′ could be arranged to switch between any number of modes.

Accordingly, considering the data transaction shown in FIG. 1, the SJ interface will initially operate in the full mode. The transmission of the four bits of control information takes 4 frames, each consisting of 3 time-slots, which takes 12 cycles.

Thereafter, a switch command is issued, which takes 5 cycles. The state machines 26′, 36′ will switch sequentially to the next mode and configure the SJ interface units 22, 32 to operate in the in mode.

Now the SJ interface will operate in the in mode. Each frame now consists of one time-slot for the transmission of data-in from the debugger 30′ to the data processing apparatus 20′. Accordingly, the first thirty bits of data-in will be transmitted in thirty cycles.

Thereafter, a switch command is issued, which takes 5 cycles. The state machines 26′, 36′ will switch sequentially to the next mode and configure the SJ interface units 22, 32 to operate in the equal mode.

Now the SJ interface will operate in the equal mode. Each frame now consists of two time-slots, one for transmission of data from the debugger 30′ to the data processing apparatus 20′ (data-in) and one for the transmission of response data from the data processing apparatus 20′ to the debugger 30′ (data-out). Accordingly, the last two bits of data-in and the two bits of data-out is transmitted in two frames, which takes 4 cycles.

Thereafter, a switch command is issued, which takes 5 cycles. The state machines 26′, 36′ will switch sequentially to the next mode and configure the SJ interface units 22, 32 to operate in the full mode.

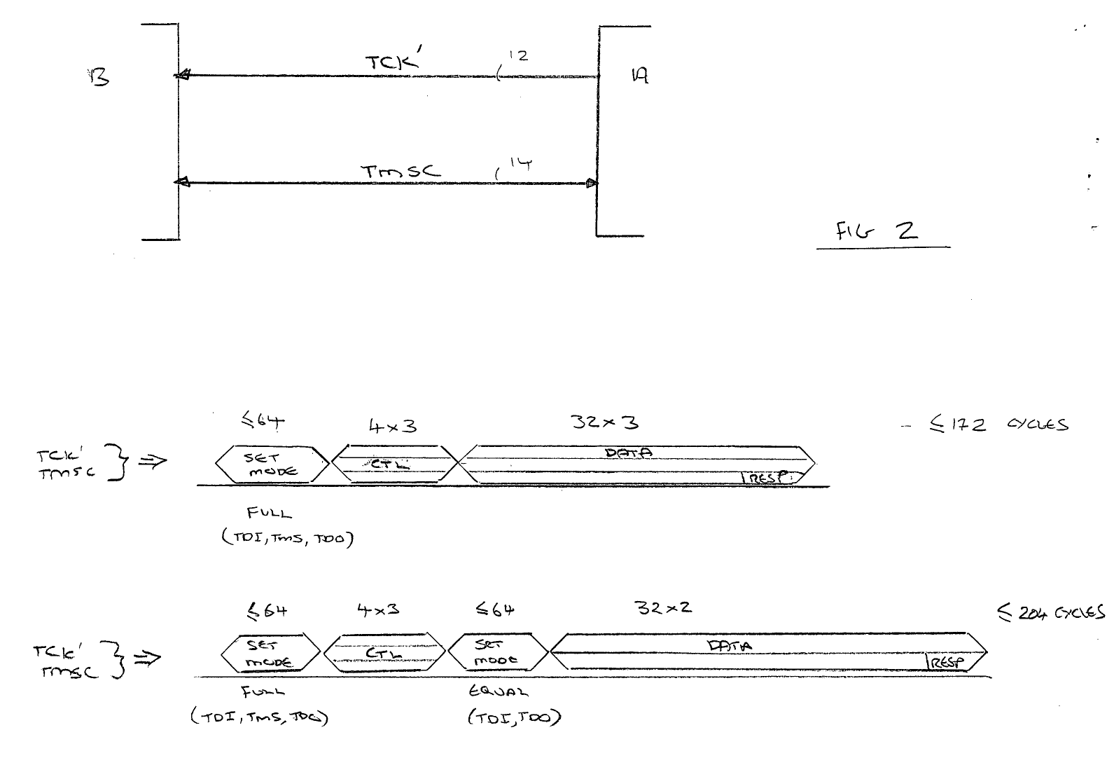

Hence, with this arrangement, the transmission of the transaction shown in FIG. 1 takes 61 cycles. Whilst this is slightly longer than the arrangement shown in FIG. 3A, it will be appreciated that having more than two modes available to switch between can provide additional flexibility to cope with the transactions other than the type shown in FIG. 1 and the time taken to perform the transaction is still significantly less than that shown in FIG. 2.

FIG. 3C illustrates a system 10′ including an arrangement of a SJ interface according to another embodiment of the present invention. In this embodiment, the state machines 26″ and 36″ now provide information on sequences of modes to be adopted. These sequences may be any particular arrangement of modes which are maintained for any particular number of cycles. For example, in this arrangement, sequence 0 is simply the full mode, which is maintained until a switch occurs, whilst sequence 1 is the in mode for 30 cycles and thereafter the equal mode is maintained until a switch occurs.

Considering now the operation of the arrangement shown in FIG. 3C when performing the data transaction shown in FIG. 1.

Initially the interface will operate in accordance with sequence 0 (the full mode). The control information is transmitted over 4 frames of 3 time-slots, which takes 12 cycles.

Thereafter, a switch command is issued, which takes 5 cycles. The state machines 26″, 36″ will switch to the next mode and configure the SJ interface units 22, 32 to operate in accordance with next sequence (sequence 1).

Accordingly, the SJ interface is configured to operate in the in mode for 30 cycles and thereafter in the equal mode. Hence, after 30 cycles of operating in the in mode, 30 bits of data-in have been transmitted. The state machines 26″, 36″ will then cause the mode to switch to the equal mode and, thereafter, the remaining two bits of data-in and the two bits of data-out will be transmitted over two frames consisting of 2 time-slots. Accordingly, this portion of the transaction takes 34 cycles to complete.

Thereafter, a further switch command will be issued, which takes 5 cycles. The state machines 26″, 36″ will switch to the next mode and configure the SJ interface units 22, 32 to operate in accordance with next sequence (sequence 0).

Hence, with this arrangement, the transaction illustrated in FIG. 1 can be performed in 56 cycles.

It will be appreciated that the above arrangement could be altered to provide difference sequences of modes. For example, sequence 0 could instead be full mode for 12 cycles followed by the in mode of 30 cycles and the equal mode for 2 cycles before reverting back to the full mode again. This will enable the number of cycles required to perform the data transaction to be reduced down to just 46 cycles.

Accordingly, sequence 0 could be configured to be optimal for data transactions having the arrangement shown in FIG. 1 and sequence 1 could be configured to be optimal for data transactions having a different arrangement. Hence, a switch command would only ever need to be issued when switching between transactions having different types or formats.

Whilst the above arrangement shows switching between just two sequences of modes, it will be appreciated that the state machines 26″, 36″ could be arranged to switch between any number of sequences made up of any number of modes.

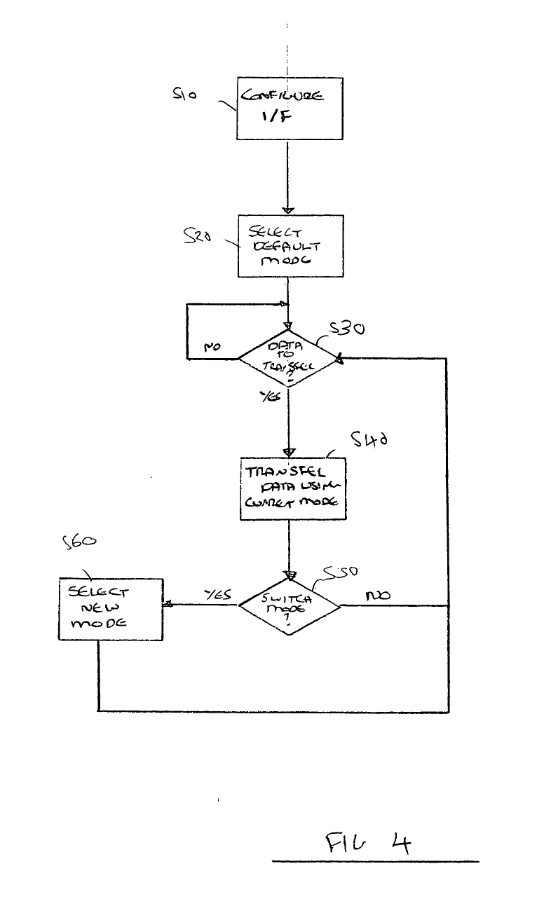

FIG. 4 is a flow chart showing the operation of the SJ interfaces illustrated in FIGS. 3A, 3B and 3C.

At step S10, the state machines are initially programmed with the particular operating mode or sequence of modes which need to be performed. Thereafter, at step S20, the default mode for the interface is selected. This may be, for example, the first mode of the state machines.

At step S30, it is determined whether there is data to be transferred. In the event that there is data to be transferred, then, at step S40, the data is transferred using the current mode.

At step S50, a determination is made as to whether a switch command had been issued.

In the event that a switch command has not been received, then processing returns to step S30 to await the next item of data to be transferred.

In the event that a switch command has been received, then processing proceeds to step S60 where a new mode or sequence of modes is selected. Thereafter, processing returns to step S30 to await the next item of data to be transferred.

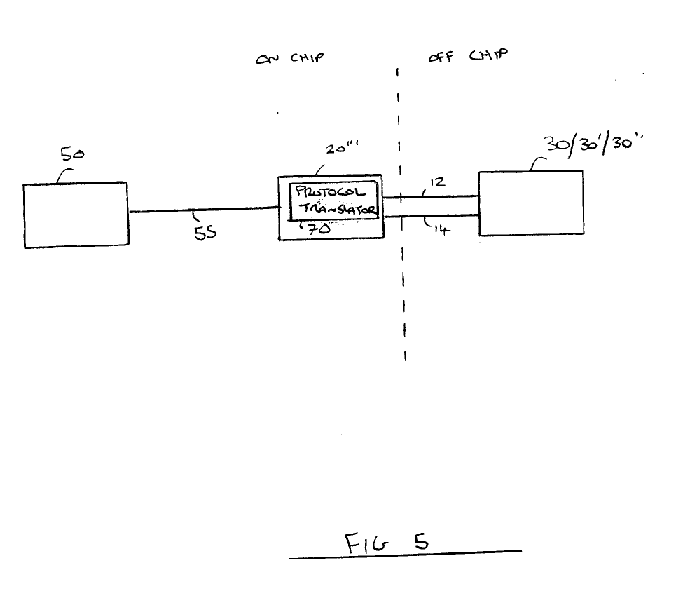

FIG. 5 illustrates a further embodiment of the present invention. In this arrangement there is provided a debugger 30, 30′, 30″ which is coupled with a data processing apparatus 20′″ using a SJ interface having a TCK′ path 12 and a TMSC path 14. The data processing apparatus 20′″ is provided on-chip and the debugger 30, 30′, 30″ is off-chip. Hence, the chip only need provide two pins to support the SJ interface.

However, the data processing apparatus 20′″ is coupled with another unit on-chip using a different interface to the SJ interface, this different interface having one or more paths 55. This different interface may be, for example, the JTAG interface described above. Accordingly, a JTAG interface may be used on-chip to communicate between one or more different apparatus or units, with the SJ interface being used to communicate off-chip.

Hence, the data processing apparatus 20′″ will typically comprise the same configuration as any of the data processing apparatus 20, 20′ or 20″, but with the additional feature of a protocol translator 70. The protocol translator 70 is operable to take the mode and signal information received over one of the interfaces and translates this to be compliant with the protocols of the other interface. In this way, the data and signals can readily be passed from one interface to the other.

It can be seen from the above that the present technique addresses the problem of relatively poor performance provided by, for example, the SJ interface, by providing within each unit a predetermined ordered list of modes to be supported by those units. The modes supported by those units are typically a subset of all the available modes. In this way, it is only necessary to provide an indication that some change is required and the mode which needs to be changed to can be determined simply by referring to the ordered list. It will be appreciated that this provides a mechanism to switch efficiently between modes, significantly reduces the amount of data required to indicate the new mode and improves the efficiency of total data transaction.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A method of controlling the configuration of a transmission path coupling a first unit and a second unit, said first unit and said second unit being configurable to support the transfer of information items over said transmission path in time-slots of successive transmission frames in accordance with a plurality of modes, each of said plurality of modes allocating differing numbers of time-slots within each frame to different types of information items, said method comprising the steps of:
programming control logic of said first unit and said second unit with an indication of an ordered subset of said plurality of modes to be supported by said first unit and said second unit;
configuring said first unit and said second unit to support the transfer said information items over said transmission path using a default one of said plurality of modes; and
responsive to an indication requesting that a different mode be selected, causing said first unit and said second unit to be configured to support the next in said ordered subset of said plurality of modes indicated by said control logic.

2. The method of claim 1, wherein said ordered subset of said plurality of modes comprises two of said plurality of modes.

3. The method of claim 1, wherein said control logic of said first unit and said second unit each comprise a state machine operable to store said subset of said plurality of modes, each state machine being responsive to said indication to cause said first unit and said second unit to be configured to switch between each of said subset of said plurality of modes.

4. The method of claim 1, wherein one of said ordered subset of said plurality of modes comprises said default mode.

5. The method of claim 1, wherein said ordered subset of said plurality of modes comprises a plurality of sequences of said plurality of modes.

6. The method of claim 5, wherein one of said sequences comprises a first of said plurality of modes operable to support transmission of a first type of information items for a first predetermined number of time-slots followed by a second of said plurality of modes operable to support transmission of a second type of information items for a second predetermined number of time-slots.

7. The method of claim 1, wherein each frame comprises a plurality of time-slots, each information item being transmittable within one of said time-slots.

8. The method of claim 1, wherein said different types of information items comprise control information and data information.

9. The method of claim 1, wherein one of said plurality of modes comprises a multiplex mode in which each time-slot within each frame is associated with a different type of information.

10. The method of claim 8, wherein said data information comprises transmission information and reception information.

11. The method of claim 10, wherein one of said plurality of modes comprises a transmission mode in which each time-slot within each frame is associated with transmission information.

12. The method of claim 10, wherein one of said plurality of modes comprises a reception mode in which each time-slot within each frame is associated with reception information.

13. The method of claim 10, wherein one of said plurality of modes comprises a duplex mode in which each time-slot within each frame is associated with either reception information or transmission information.

14. The method of claim 1, wherein the step of programming control logic comprises programming control logic of said first unit and said second unit with said indication of said ordered subset of said plurality of modes to be supported by said first unit and said second unit based on expected quantities and types of information items predicted to be transmitted over said transmission path.

15. The method of claim 1, wherein said transmission path comprises a single bi-directional path.

16. The method of claim 1, wherein said transmission path comprises a single bi-directional path and a path carrying a clock signal.

17. The method of claim 1, wherein said first unit comprises a debug unit and said second unit comprises a data processing unit to be debugged.

18. The method of claim 1, wherein said first unit comprises a test unit and said second unit comprises a data processing unit to be tested.

19. The method of claim 1, wherein said first unit comprises a configuration unit and said second unit comprises a data processing unit to be configured.

20. The method of claim 1, wherein said indication has a data length which is shorter than other control sequences used to configure said transmission path.

21. The method of claim 1, comprising the step of:
transferring said information items over said transmission path in accordance with the currently selected mode.

22. The method of claim 1, wherein there is provided a second transmission path coupling a third unit with one of said first and said second units, said method further comprising the steps of:
reformatting data received by said one of said first and said second units for transmission over said second transmission path; and
transmitting said data received by said one of said first and said second units over said second transmission path.

23. The method of claim 22, wherein said second transmission path couples said third unit with said second unit, said third unit and said second unit being provided on-chip and said first unit being provided off-chip.

24. A system comprising:
a first unit;
a second unit;
a transmission path coupling said first unit and said second unit,
wherein said first unit and said second unit are configurable to support the transfer of information items over said transmission path in time-slots of successive transmission frames in accordance with a plurality of modes, each of said plurality of modes allocating differing numbers of time-slots within each frame to different types of information items, said first unit and said second unit comprising:
control logic programmable with an indication of an ordered subset of said plurality of modes to be supported by that unit;
configuration logic operable to configure that unit to support the transfer said information items over said transmission path using a default one of said plurality of modes; and
change logic responsive to an indication requesting that a different mode be selected to cause that unit to be configured to support the next in said ordered subset of said plurality of modes indicated by said control logic.

25. The system of claim 24, further comprising:
a third unit;
a second transmission path coupling a third unit with one of said first and said second units; and
reformatting logic operable to reformat data received by said one of said first and said second units for transmission over said second transmission path and to transmit said data received by said one of said first and said second units over said second transmission path.

26. The system of claim 25, wherein said second transmission path couples said third unit with said second unit, said third unit and said second unit being provided on-chip and said first unit being provided off-chip.

27. A unit for controlling the configuration of a transmission path coupled thereto and to a second unit, said unit being configurable to support the transfer of information items over said transmission path in time-slots of successive transmission frames in accordance with a plurality of modes, each of said plurality of modes allocating differing numbers of time-slots within each frame to different types of information, said unit comprising:
control logic programmable with an indication of an ordered subset of said plurality of modes to be supported;
configuration logic for supporting the transfer said information items over said transmission path using a default one of said plurality of modes; and
change logic responsive to an indication requesting that a different mode be selected for causing the next in said ordered subset of said plurality of modes indicated by said control logic to be supported.

28. The unit of claim 27, further comprising:
reformatting logic for reformatting data received by said one of said first and said second units for transmission over a second transmission path to a third unit and for transmitting said data received by said one of said first and said second units over said second transmission path.

29. The unit of claim 28, wherein said second transmission path is provided on-chip with said unit and said transmission path and said first unit is provided off-chip.
